(19) United States
(12) Patent Application Publication
(10) Pub. No.: US 2015/0032710 A1
(43) Pub. Date: Jan. 29, 2015

(54) Method Of Communicating Changes In A Main Database To A Client Application

(71) Applicant: BROADVIEW NETWORKS, INC., Rye Brook, NY (US)

(72) Inventors: Youssef Latrous, Ottawa (CA); Ronald Brett Buckingham, Carp (CA); Ravik Tupja, Ottawa (CA)

(73) Assignee: BROADVIEW NETWORKS, INC., Rye Brook, NY (US)

(21) Appl. No.: 13/952,551

(22) Filed: Jul. 26, 2013

(51) Int. Cl. G06F 17/30; H04L 29/06

(52) U.S. Cl. CPC G06F 17/30371; G06F 17/30227; H04L 67/42
USPC 707/703

(57) ABSTRACT

A method is described for communicating changes in a main database to a database cache associated with a client application. The main database is stored on a server that is remote from and in communication with the database cache. The method includes: receiving, at an emitter associated with the main database, a set of changes in the main database, each change in the set of changes having a transaction identifier (ID) associated with an atomic transaction; queuing, at the emitter, the received set of changes until a commit associated with the atomic transaction is received; and in response to receipt of the commit, sending a transaction notification from the emitter to a publisher, the transaction notification corresponding to all changes associated with the atomic transaction and having the same transaction ID. Advantageously, transaction-level notifications are sent, rather than row-level notifications.

### FIELD

The present disclosure relates generally to data communications, such as digital telephony. More specifically, the present disclosure relates to a method of communicating changes in a database to a client application that is remote from the database, such as for updating a database cache.

### BACKGROUND

Data communications systems are used for the transmission and reception of data, including audio and video traffic. In a virtual phone system, or digital telephony application, a main database is often used to store a large volume of data, some of which is often needed by a client application. In some implementations, a client application keeps a local cache, or copy, of the main database, or a portion thereof, in order to be able to perform real-time, or near real-time, operations using the local database cache. The client application is in communication with the main database to keep the database cache up-to-date.

Database replication methods are unsuitable for communicating changes in a main database to a client application that is in communication with the main database, since the client application does not communicate using the same protocol as the main database. Moreover, known approaches of communicating changes in a main database to a client application are unsuitable because the unit of data change upon which the communication is based is a change to a row-level entity in the database, which has concurrency problems, problems with inconsistent data, and may lead to failure of a larger transaction of which the change is only a part.

Improvements in methods of communicating changes in a main database to client applications are therefore desirable.

### BRIEF DESCRIPTION OF THE DRAWINGS

Embodiments of the present disclosure will be described, by way of example, with reference to the drawings and to the following description, in which:

FIG. 1 is a block diagram of a virtual phone system in accordance with an embodiment of the present disclosure;

FIG. 2 is a flowchart illustrating a method of communication changes to a database in accordance with an embodiment of the present disclosure;

FIG. 3 is a logic flow diagram illustrating a method of communication changes to a database in accordance with another embodiment of the present disclosure.

### DETAILED DESCRIPTION

In an embodiment, a method is provided of communicating changes in a main database to a database cache associated with a client application, the main database being stored on a server that is remote from and in communication with the database cache. The method includes: receiving, at an emitter associated with the main database, a set of changes in the main database, each change in the set of changes having a transaction identifier (ID) associated with an atomic transaction; queuing, at the emitter, the received set of changes until a commit associated with the atomic transaction is received; and in response to receipt of the commit, sending a transaction notification from the emitter to a publisher, the transaction notification corresponding to all changes associated with the atomic transaction and having the same transaction ID.

In an example embodiment, the atomic transaction comprises a begin statement, and wherein queuing the received set of changes is performed in response to receipt of the begin statement.

In an example embodiment, the atomic transaction comprises a begin statement, and wherein the transaction ID is assigned in response to receipt of the begin statement.

In an example embodiment, the method further includes, at the publisher: obtaining a set of change data associated with the set of changes; and sending, from the publisher to the client application, an atomic notification message comprising time-ordered instructions for updating the database cache based on the set of change data, the message being in a format interpretable by the client application.

In an example embodiment, the atomic notification message comprises a time-ordered representation of the set of change data and the set of changes.

In an example embodiment, the method further includes: receiving, at a client application, the atomic notification message, and changing the database cache associated with the client application based on the atomic notification message. In an example embodiment, the method includes parsing the received atomic notification message to obtain the time-ordered instructions and the set of change data.

In an example embodiment, the method includes ignoring, at the client application, the atomic notification message received from the main database after initial loading of data from the main database into the database cache associated with the client application.

In an example embodiment, the atomic notification message is emitted to a plurality of client applications, wherein each client application is associated with a separate database cache. In an example embodiment, the method further includes, receiving, at each client application, the atomic notification message, and changing the database cache associated with each client application based on the received atomic notification message.

In an embodiment, the present disclosure provides a non-transitory computer readable medium comprising computer-readable instructions executable by a processor to perform a method as described and illustrated herein.

In an embodiment, the present disclosure provides a system comprising a server. The server comprises a database for storing data, and an emitter associated with the database. The emitter is configured to: receive a set of changes in the main database, each change in the set of changes having a transaction identifier (ID) associated with an atomic transaction; queue the received set of changes until a commit associated with the atomic transaction is received; and in response to receipt of the commit, send a transaction notification, the transaction notification corresponding to all changes associated with the atomic transaction and having the same transaction ID.

In an example embodiment, the atomic transaction comprises a begin statement, and wherein the emitter queues the received set of changes in response to receipt of the begin statement.

In an example embodiment, the atomic transaction comprises a begin statement, and wherein the emitter assigns the transaction ID in response to receipt of the begin statement.

In an example embodiment, the system further includes a publisher in communication with the server, wherein the emitter sends the transaction notification to the publisher, the publisher configured to: obtain a set of change data associated with the set of changes; and send, from the publisher to the client application, an atomic notification message comprising time-ordered instructions for updating the database cache based on the set of change data, the message being in a format interpretable by the client application.

In an example embodiment, wherein the atomic notification message sent by the publisher comprises a time-ordered representation of the set of change data and the set of changes.

In an example embodiment, the system further includes the client application and a database cache associated with the client application, the database cache being remote from and in communication with the server, wherein the client application is configured to: receive the atomic notification message, and change the database cache associated with the client application based on the atomic notification message.

In an example embodiment, the client application is configured to ignore the atomic notification message received from the database after initial loading of data from the database into the database cache associated with the client application.

In an example embodiment, the system further includes a plurality of client applications, and wherein the atomic notification message is emitted to the plurality of client applications, wherein each client application is associated with a separate database cache. In an example embodiment, the plurality of client applications are each configured to receive the atomic notification message and change the database cache associated with the client application based on the received atomic notification message.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been descried in detail to avoid obscuring the embodiments described. The description is not considered as limited to the scope of the embodiments described.

For the purpose of illustration, the method of communicating changes in a main database to a database cache associated with a client application in accordance with the present disclosure is described herein when implemented in a virtual phone system. A person of ordinary skill in the art, however, will readily recognize that the method described herein may be implemented in any system in which client applications are in communication with a main database, for example, fault management systems, financial systems, and real-time command and control systems.

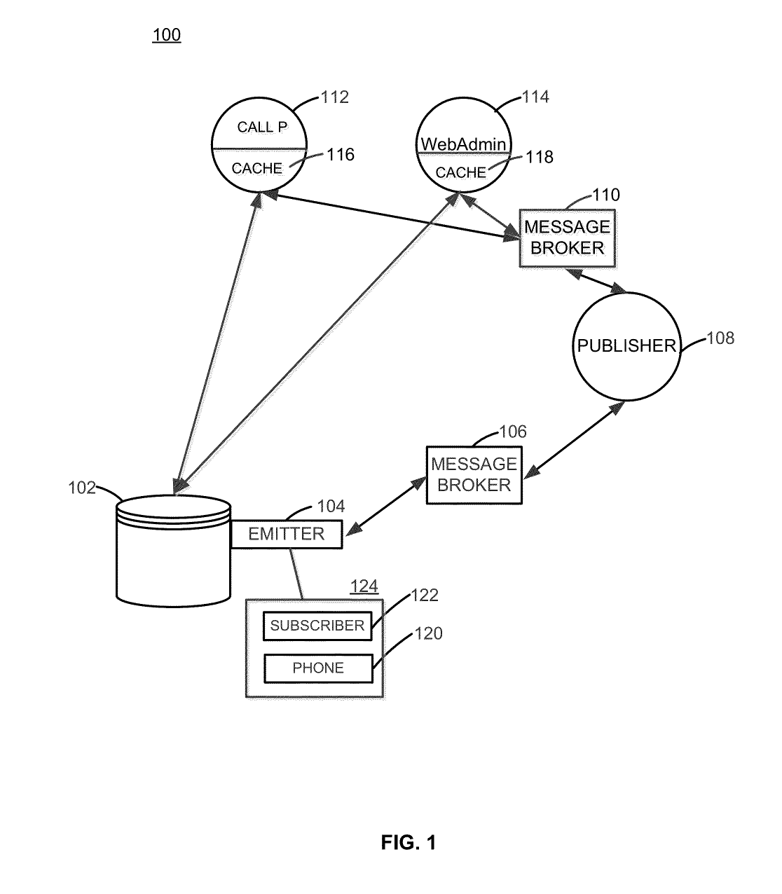

A block diagram of an example of a virtual phone system 100 is shown in FIG. 1. In an example embodiment, the virtual phone system 100 is a hosted private branch exchange that provides telephone services to small or medium sized businesses. The private branch exchange may be operated and maintained by a voice-over-IP (VoIP) service provider. The virtual phone system 100 includes a database 102, an emitter 104, a first message broker 106, a transaction publisher 108, a second message broker 110, and client applications that are in communication with the database 102. In an implementation, the first and second message brokers 106, 110 are separate logical entities of the same physical entity.

In an embodiment, the message broker is part of a subscribe/publish infrastructure. The message broker provides queues that can be viewed as communication trunks between producers and consumers. Different entities in the system can use different queues to communicate with each other, using a common infrastructure referred to as the message broker. An example implementation of the message broker is known to those of skill in the art as the advanced messaging queuing protocol, such as implemented by RabbitMQ.

For the purposes of the present example, the virtual phone system 100 includes two client applications, a Call Processing client application 112, and a Web Admin client application 114. While the virtual phone system 100 shown in FIG. 1 includes two client applications, the virtual phone system 100 may include any number of client applications. Each client application is in communication with the database 102.

The database 102 is the main database of the virtual phone system 100 and stores all the provisioned information for a business, including the tenants of the virtual phone system 100, the sites of the tenants, the zones within the sites of the tenants, the number of and the location of media servers, the number of and the location of voice mail servers, subscribers of the virtual phone system 100, and the phone numbers for each of the subscribers. The Call Processing client application 112 is software that runs all the phones of the virtual phone system 100. The Call Processing client application 112 is in communication with the database 102 and maintains a data layer that includes an in-memory object cache 116, or database cache, that stores a copy of data stored in the database 102. In an example embodiment, the database cache 116 stores a copy of a portion of the data stored in the database 102. In another example embodiment, the database cache 116 stores a copy of all of the data stored in the database 102.

The Call Processing client application 112 reads data from, and writes data to, the database 102, for example, phone registration data and feature activation data. The phone registration data may include, for example, a MAC address for each phone of the virtual phone system 100, an IP address for each phone of the virtual phone system 100, and login/logouts for each phone of the virtual phone system 100. The feature activation data may include, for example, toggling call forwarding and twinning, and device mapping. The Call Processing client application 112 is notified of any changes to the data stored in the database 102 in real-time. The Call Processing client application 112 is not a structured query language (SQL) application, and thus cannot process or interpret SQL messages.

The Web Admin client application 114 is also software that provides a web administration interface for a business and for the VoIP service provider for configuring the virtual phone system 100. The WebAdmin client application 114 is in communication with the database 102 and maintains a data layer that includes an in-memory object cache 118, or database cache, that stores a copy of data stored in the database 102. In an example embodiment, the database cache 118 stores a copy of a portion of the data stored in the database 102. In another example embodiment, the database cache 118 stores a copy of all of the data stored in the database 102. The WebAdmin client application 114 reads data from, and writes data to, the database 102. The WebAdmin client application 114 is notified of any changes to the data stored in the database 102 in real-time. The WebAdmin client application 114 is also not a structured query language (SQL) application, and thus cannot process or interpret SQL messages.

The emitter 104 of the virtual phone system 100 is associated with the database 102. In an example embodiment, the emitter 104 includes a trigger (not shown) and an extension (not shown) that receives database commit events from the main database 102. An atomic transaction is a set of individual changes. An atomic transaction starts when the main database 102 sends a BEGIN statement and ends when the main database 102 sends a COMMIT statement. A COMMIT statement indicates that a transaction has been successfully completed by the main database 102 (i.e., all the individual changes of an atomic transaction are being permanently saved to the main database 102).

The number of individual changes in an atomic transaction is unknown to the emitter 104 when the emitter 104 receives a BEGIN statement from the main database 102. The main database 102 assigns a unique identifier, referred to herein as a transaction identifier (XID), to an atomic transaction. In an example embodiment, the XID is assigned in response to receipt of the BEGIN statement.

When the emitter 104 receives the BEGIN statement from the main database 102, the trigger of the emitter 104 stores, for every individual change, a record of the individual change. The record of the individual change may be, for example, an insert statement, a delete statement, an update statement, or any other type of change statement for the main database 102. The trigger also queues a notification to the message broker. These messages, or notifications, are on hold at this stage.

When the emitter 104 receives the BEGIN statement from the main database 102, the trigger of the emitter 104 stores, for every individual change, a record of the individual change. The record of the individual change may be, for example, an insert statement, a delete statement, an update statement, or any other type of change statement for the main database 102. The trigger also queues a message or notification to the message broker. These queued notifications, or messages, are on hold at this point.

When the emitter 104 receives the COMMIT statement from the main database 102, the extension of the emitter 104 sends the queued messages for the transaction from message broker 106 to the publisher 108. When the publisher 108 receives any one of the queued messages from the message broker 106, the publisher 108 reads from the database, the specially recorded individual data changes, builds the atomic transaction, and formats the atomic transaction in a format that is interpretable by the client application. The publisher 108 then sends the atomic message to the client applications, such as the Call Processing client application 112 and the WebAdmin client application 114.

If a transaction fails, or rolls back, for example in the absence of receipt of a COMMIT, all of the recorded individual changes for the atomic transaction and the queued messages are discarded, and no notification is sent from the emitter 104 to the publisher 108. It is worth noting that the database commit event has no information about the changes that just happened. The determination of whether a transaction has failed can be made based on whether a COMMIT is received within a predetermined time period from when the BEGIN is received.

The method of the present disclosure will now be described with reference to an example. In the present example, the Call Processing client application 112 detects a new phone in the virtual phone system 100. The Call Processing client application 112 generates an atomic transaction to change a subscriber record so that the subscriber record points to the new phone. The atomic transaction includes two changes: a first change 120, adding the new phone number to the main database 102; and a second change 122, updating the subscriber record identifier in the main database 102 so that the subscriber record points to the new phone. The Call Processing client application 112 updates the subscriber record stored in the database 102 through the database application programming interface (API).

The emitter 104 receives a BEGIN statement followed by the two changes 120, 122. The emitter 104 receives the first change 120 from the database 102, which indicates that a subscriber record stored in the database 102 has changed, such as by identifying the subscriber record. In an implementation, the first change 120 is similar to a row-level change indication in known approaches. The emitter 104 also receives the second change 122 from the database 102 which indicates that a new phone is associated with the subscriber record, such as by indicating the new phone number.

In this example, the set of changes in the atomic transaction comprises first and second changes 120 and 122. According to an embodiment of the present disclosure, a notification is sent after a COMMIT is received from the main database 102, confirming that 120 and 122 are all changes in the set. This can be described as an atomic transaction-level notification. In known approaches, notifications are sent at an individual change level, such as a row level, that is a single entry in a single table. In an example embodiment, the atomic transaction-level notification is sent from the emitter 104 to the publisher 108 via the message broker 106.

In response to the transaction notification being received at the publisher, the publisher 108 obtains, from the database 102, change data that is associated with the first change 120, and change data associated with the second change 122. After the change data associated with the first and second changes 120, 122 is obtained, the publisher 108 builds the atomic transaction, and formats the atomic transaction in a format that is interpretable by the client application. The publisher 108 then sends the atomic message to the client applications, such as the Call Processing client application 112 and the WebAdmin client application 114.

In an example embodiment, the publisher 108 translates the information received from the emitter 104 into an atomic notification message which is in a format that is interpretable by the Call Processing client application 112, and the WebAdmin client application 114, for example, text.

In an embodiment, the atomic notification message includes time-ordered instructions for changing the data stored in the database cache of the Call Processing client application 110 and the Web Admin Client application 112, including the obtained change data. In an example embodiment, the atomic notification message is in a serialized strictly ordered atomic form.

In contrast to the method of the present disclosure, in known methods of communicating changes from a database to a client application, an emitter associated with the database receives row-level changes to the database (i.e., a single entry in a single table stored in the database), and sends a message for each row-level entity change to a client application. A separate message is sent by the emitter, and passed on to the message broker and publisher, for each a row-level entity change to the database. Sending separate messages for each row-level entity change, however, leads to concurrency problems, problems with inconsistent data, and possibly leads to failure when updating an in-memory object cache of a client application. For example, if a set of changes together constitute an atomic transaction, those changes must be performed in a specific order and when all of the required resources are confirmed to be available, or have been committed. If the change-related messages are sent on the change-level, as opposed to the atomic transaction-level, the changes may not be performed in the correct order, which can lead to failure of the entire transaction.

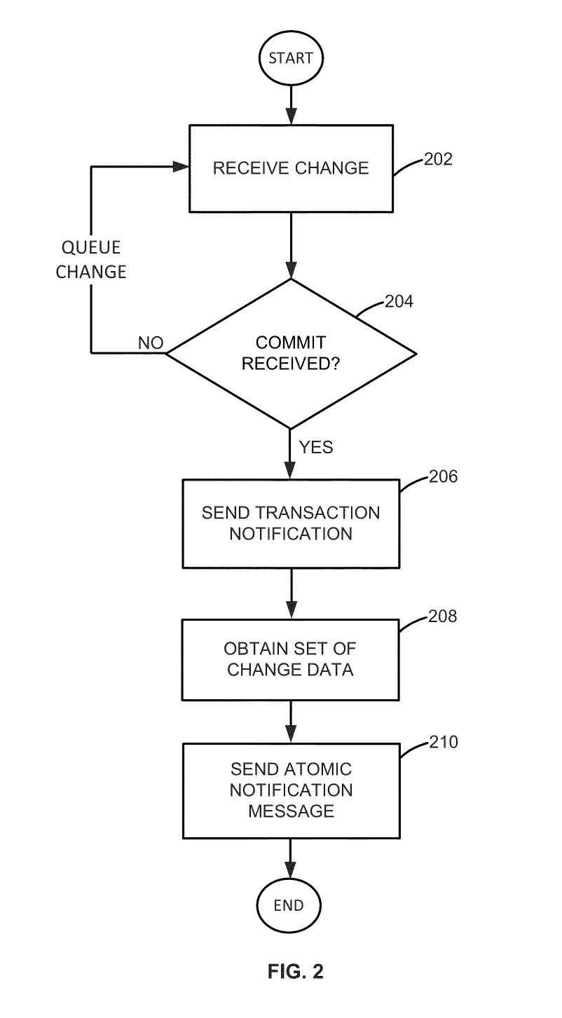

A flowchart illustrating a method of communicating an atomic transaction from the master database to a database cache associated with a client application is illustrated in FIG. 2. The method may be carried out by software executed, for example, by one or more processors, such as at the emitter 104, the publisher 108, or both. Coding of software for carrying out such a method is within the scope of a person of ordinary skill in the art given the present description. The method may contain additional or fewer processes than shown and/or described, and may be performed in a different order. Computer-readable code executable by at least one processor of the electronic device to perform the method may be stored in a computer-readable storage medium, device, or apparatus, which may be a non-transitory or tangible storage medium, device, or apparatus.

The method of FIG. 2 starts in response to receipt of a BEGIN statement from the main database. A change is received 202 at the emitter 104 from the main database 102. The change is part of an atomic transaction and the atomic transaction includes a set of changes. The change is associated with a transaction identifier (ID). A determination is made 204 as to whether the COMMIT associated with the transaction ID has been received. If not, the change is queued, such as in the emitter 104. The received changes are all queued, at the emitter, until the COMMIT is received, and no notification message is sent. In response to receipt of the COMMIT, a transaction notification is sent 206 from the emitter to the publisher, the transaction notification corresponding to all changes associated with the atomic transaction and having the same transaction ID.

The publisher 108, in response to receipt of the transaction notification, obtains 208 a set of change data associated with the set of changes, and generates an atomic notification message that includes the set of changes in time order, and the change data associated with the set of changes. The atomic notification message is then sent 210 from the transaction publisher 108 in a format that is native to, or interpretable by, a client application. The atomic notification message comprises time-ordered instructions that include the set of change data for updating the cache.

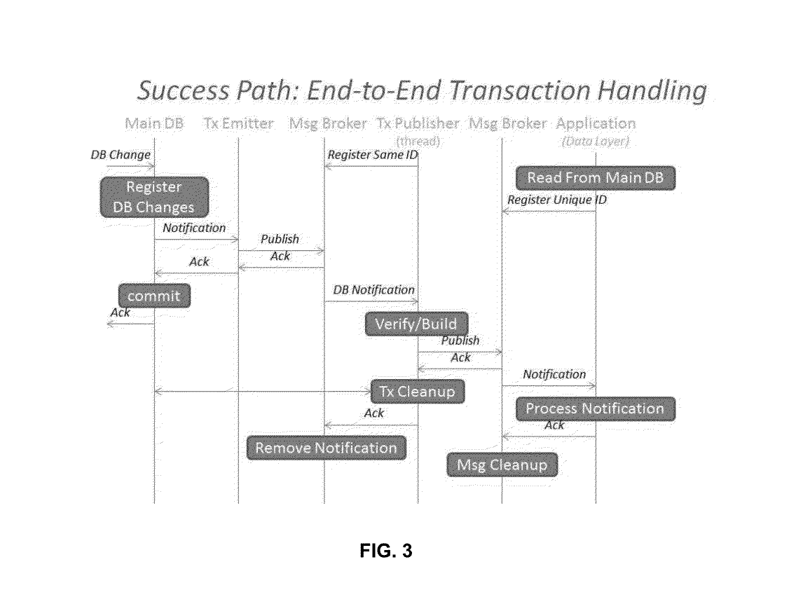

FIG. 3 is a logic flow diagram illustrating a method of communication changes to a database in accordance with another embodiment of the present disclosure.

At start-up of the virtual phone system 100, the transaction publisher 108 registers with the message broker 106 to receive database notifications from the emitter 104, and sends change notifications to applications, such as the WebAdmin client application 114. At the same time, the other client applications of the virtual phone system 100, such as the Call Processing client application 112, register with the message broker 106 in order to receive change notifications from the publisher 108.

When a change occurs in the database 102, the emitter 104 sends out an event, or change, to the publisher 108, using the message broker 106. The publisher upon reception of the event, or change, builds an atomic notification message that includes of all changes forming part of a transaction, and sends the atomic notification message to the client applications of the virtual phone system 100, such as Call Processing client application 110.

When the Call Processing client application 110 receives the atomic notification message from the publisher 108, through message broker 110. The Call Processing client application 110 then processes the atomic notification message, and updates the data in the database cache 116 based on the atomic notification message.

At start-up of the client applications, such as the Call Processing client application 110, the atomic notification messages received from publisher 108 are ignored after initial loading of data from the main database 102 into the database cache 114. The approach illustrated in FIG. 3 also helps manage the failure of intermediate components by reconnecting and maintaining database change ordering, such as by detecting and reporting out of order changes to the main database 102.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method of communicating changes in a main database to a database cache associated with a client application, the main database being stored on a server that is remote from and in communication with the database cache, the method comprising:
receiving, at an emitter associated with the main database, a set of changes in the main database, each change in the set of changes having a transaction identifier (ID) associated with an atomic transaction;
queuing, at the emitter, the received set of changes until a commit associated with the atomic transaction is received; and
in response to receipt of the commit, sending a transaction notification from the emitter to a publisher, the transaction notification corresponding to all changes associated with the atomic transaction and having the same transaction ID.

2. The method of claim 1 wherein the atomic transaction comprises a begin statement, and wherein queuing the received set of changes is performed in response to receipt of the begin statement.

3. The method of claim 1 wherein the atomic transaction comprises a begin statement, and wherein the transaction ID is assigned in response to receipt of the begin statement.

4. The method of claim 1 further comprising, at the publisher:
obtaining a set of change data associated with the set of changes; and
sending, from the publisher to the client application, an atomic notification message comprising time-ordered instructions for updating the database cache based on the set of change data, the message being in a format interpretable by the client application.

5. The method of claim 4, wherein the atomic notification message comprises a time-ordered representation of the set of change data and the set of changes.

6. The method of claim 4, further comprising:
receiving, at a client application, the atomic notification message, and
changing the database cache associated with the client application based on the atomic notification message.

7. The method of claim 4, comprising ignoring, at the client application, the atomic notification message received from the main database after initial loading of data from the main database into the database cache associated with the client application.

8. The method of claim 4, wherein the atomic notification message is emitted to a plurality of client applications, wherein each client application is associated with a separate database cache.

9. The method of claim 8, further comprising, receiving, at each client application, the atomic notification message, and changing the database cache associated with each client application based on the received atomic notification message.

10. A non-transitory computer readable medium comprising computer-readable instructions executable by a processor to perform the method of claim 1.

11. A system comprising:
a server comprising:
a database for storing data;
an emitter associated with the database and configured to:
receive a set of changes in the main database, each change in the set of changes having a transaction identifier (ID) associated with an atomic transaction;
queue the received set of changes until a commit associated with the atomic transaction is received; and
in response to receipt of the commit, send a transaction notification, the transaction notification corresponding to all changes associated with the atomic transaction and having the same transaction ID.

12. The system of claim 11 wherein the atomic transaction comprises a begin statement, and wherein the emitter queues the received set of changes in response to receipt of the begin statement.

13. The system of claim 11 wherein the atomic transaction comprises a begin statement, and wherein the emitter assigns the transaction ID in response to receipt of the begin statement.

14. The system of claim 11 further comprising a publisher in communication with the server, wherein the emitter sends the transaction notification to the publisher, the publisher configured to:
obtain a set of change data associated with the set of changes; and
send, from the publisher to the client application, an atomic notification message comprising time-ordered instructions for updating the database cache based on the set of change data, the message being in a format interpretable by the client application.

15. The system of claim 14, wherein the atomic notification message sent by the publisher comprises a time-ordered representation of the set of change data and the set of changes.

16. The system of claim 14 further comprising the client application and a database cache associated with the client application, the database cache being remote from and in communication with the server, wherein the client application is configured to:
receive the atomic notification message, and
change the database cache associated with the client application based on the atomic notification message.

17. The system of claim 16, wherein the client application is configured to ignore the atomic notification message received from the database after initial loading of data from the database into the database cache associated with the client application.

18. The system of claim 16, further comprising a plurality of client applications, and wherein the atomic notification message is emitted to the plurality of client applications, wherein each client application is associated with a separate database cache.

19. The system of claim 18, wherein the plurality of client applications are each configured to receive the atomic notification message and change the database cache associated with the client application based on the received atomic notification message.
